(19) United States
(12) Patent Application Publication
(10) Pub. No.: US 2024/0346545 A1
(43) Pub. Date: Oct. 17, 2024

(54) Client-to-Client Asset Hosting and Serving for Digital Advertising

(71) Applicant: GOOGLE LLC, Mountain View, CA (US)

(72) Inventors: Alex Jacobson, Mountain View, CA (US); Nick Sabatino, Mountain View, CA (US)

(21) Appl. No.: 18/571,891

(22) PCT Filed: Dec. 29, 2021
(86) PCT No.: PCT/US21/65453

§ 371 Date: Dec. 19, 2023

(51) Int. Cl. G06Q 30/0242; G06Q 30/0251

(52) U.S. Cl. CPC G06Q 30/0242; G06Q 30/0251

(57) ABSTRACT

Techniques for increasing security and privacy while requesting digital advertisements for mobile applications are provided. Such techniques use a separate ad management application on the same mobile computing device as an ad-requesting application to receive an ad request and to provide an ad response that provides digital ad assets to the ad-requesting application. The ad request and the ad response may be remote procedure calls. To obtain and provide the digital ad assets of a digital advertisement, the ad management application generates an ad request message based upon the ad request (which may include augmenting the ad request), sending the ad request message to a supply-side platform (SSP) of a digital advertising network, receiving an ad response message including the digital ad assets from the SSP, and sending the ad response with the digital ad assets to the ad-requesting application for display to a user of the mobile computing device.

### FIELD OF THE DISCLOSURE

The present disclosure generally relates to improvements in the field of digital advertisement acquisition on mobile devices, particularly for native mobile applications.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Many native mobile applications obtain digital advertisements through supply-side platforms (SSPs) of ad exchange systems through advertising software development kits (SDKs) in the applications. These SDKs either communicate directly with SSPs or with publisher ad servers run by large publishers to support ad placement within their own applications. Because these advertising SDKs are incorporated into the applications, they have the same access permissions applicable to the applications, thus creating potential security and privacy issues. Detecting manipulation of environmental and anti-fraud signals is also hindered by the publisher's ability to manipulate the signals, either within the application or at a publisher ad server. Similar manipulation can occur with respect to telemetry and analytics signals. Additionally, the inclusion of duplicate advertising SDKs in multiple applications wastes storage resources on the mobile device and confuses error attribution between application publishers and SDK publishers in the event of application issues. Moreover, updating an advertising SDK requires updating one or more applications that use such SDK.

### SUMMARY

Techniques for addressing such problems with existing digital advertising provisioning techniques are provided. One example embodiment of the techniques of this disclosure is a computer-implemented method in a mobile computing device, comprising: receiving an ad request from an ad-requesting application operating on the mobile computing device to an ad management application operating on the mobile computing device; generating an ad request message via the ad management application based upon the ad request; sending the ad request message from the ad management application to a supply-side platform server of a digital advertising network via a communication network; receiving an ad response message from the supply-side platform server to the ad management application in response to the ad request message, wherein the ad response message includes one or more digital ad assets associated with a digital advertisement; and sending an ad response from the ad management application to the ad-requesting application, wherein the ad response includes the one or more digital ad assets for display to a user of the mobile computing device by the ad-requesting application.

Another example embodiment of the techniques of this disclosure is a mobile computing device, comprising: one or more processors; and a computer-readable memory coupled to the one or more processors and storing instructions thereon that, when executed by the one or more processors, cause the mobile computing device to: receive an ad request from an ad-requesting application operating on the mobile computing device to an ad management application operating on the mobile computing device; generate an ad request message via the ad management application based upon the ad request; send the ad request message from the ad management application to a supply-side platform server of a digital advertising network via a communication network; receive an ad response message from the supply-side platform server to the ad management application in response to the ad request message, wherein the ad response message includes one or more digital ad assets associated with a digital advertisement; and send an ad response from the ad management application to the ad-requesting application, wherein the ad response includes the one or more digital ad assets for display to a user of the mobile computing device by the ad-requesting application.

Yet another example embodiment of the techniques of this disclosure is a computer-readable memory coupled to one or more processors and storing instructions thereon that, when executed by the one or more processors of a mobile computing device, cause the one or more processors to: receive an ad request from an ad-requesting application operating on the mobile computing device to an ad management application operating on the mobile computing device; generate an ad request message via the ad management application based upon the ad request; send the ad request message from the ad management application to a supply-side platform server of a digital advertising network via a communication network; receive an ad response message from the supply-side platform server to the ad management application in response to the ad request message, wherein the ad response message includes one or more digital ad assets associated with a digital advertisement; and send an ad response from the ad management application to the ad-requesting application, wherein the ad response includes the one or more digital ad assets for display to a user of the mobile computing device by the ad-requesting application.

In some instances of the foregoing example embodiments, the ad request comprises a remote procedure call from the ad-requesting application to the ad management application. In further instances, the ad-requesting application is a native mobile application without an advertising software development kit. In yet further instances, generating the ad request message comprises signing the ad request message with a cryptographic key on the mobile computing device.

In further instances of the foregoing example embodiments, the ad request message contains an augmented ad request, and generating the ad request message comprises (i) collecting local environment data associated with the mobile computing device and (ii) augmenting information of the ad request with the local environment data to generate the augmented ad request. In some such instances, the ad-requesting application has a first set of permissions for accessing resources of the mobile computing device, while the ad management application has a second set of permissions for accessing resources of the mobile computing device that is different from the first set of permissions, such that the local environment data is collected by the ad management application according to the limitations of the second set of permissions. In further instances, the local environment data comprises one or more of a type of the mobile computing device, an age of the mobile computing device, or a location of the mobile computing device. In yet further instances, the local environment data comprises one or more of a user identifier associated with the user, a user profile associated with the user, or one or more user characteristics associated with the user.

In still further instances, the foregoing example embodiments may additionally include: receiving an analytics notification from the ad-requesting application to the ad management application, wherein the analytics notification contains one or both of telemetry data or analytics data regarding interaction of the user with the one or more digital ad assets displayed by the ad-requesting application; generating an analytics message via the ad management application based upon the analytics notification; and sending the analytics message from the ad management application to the supply-side platform server via the communication network.

In yet further instances, the foregoing example embodiments may additionally include: receiving an additional ad request from an additional ad-requesting application operating on the mobile computing device to the ad management application; generating an additional ad request message via the ad management application based upon the additional ad request; sending the additional ad request message from the ad management application to the supply-side platform server via the communication network; receiving an additional ad response message from the supply-side platform server to the ad management application in response to the additional ad request message, wherein the additional ad response message includes one or more additional digital ad assets; and sending an additional ad response from the ad management application to the additional ad-requesting application, wherein the additional ad response includes the one or more additional digital ad assets for display to the user of the mobile computing device by the additional ad-requesting application.

### BRIEF DESCRIPTION OF THE DRAWINGS

The figures described below depict various aspects of the systems and methods disclosed herein. Advantages will become more apparent to those skilled in the art from the following description of the embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive. Further, wherever possible, the following description refers to the reference numerals included in the following figures, in which features depicted in multiple figures are designated with consistent reference numerals.

FIG. 1 illustrates a block diagram of an example prior art digital advertising system including a mobile computing device having an SDK for each ad-requesting application.

FIG. 2 illustrates a block diagram of an example digital advertising system including a mobile computing device having an ad management application.

FIG. 3 illustrates a flow diagram of an example digital ad request method using an ad management application.

FIG. 4 illustrates a flow diagram of an example digital ad display method using an ad management application.

FIG. 5 illustrates a sequence diagram of an example digital ad provisioning process using an ad management application.

FIG. 6 illustrates a block diagram of an example computer system for a mobile computing device.

### DETAILED DESCRIPTION

To address the problems in the existing techniques of requesting and serving digital advertisements, a separate application is configured to handle ad requests from other applications on the same mobile computing device. This ad management application receives ad requests assembled by ad-requesting applications to receive digital ad assets for display to a user of the mobile device. Such an ad request may be sent as a remote procedure call (RPC), such that the ad-requesting application does not need an advertising SDK or may include only a minimal advertising SDK to send such RPC ad requests. The ad management application obtains local environment data to augment the ad request and generates an ad request message. Generating the ad request message may include encrypting or otherwise securing the augmented ad request in order to ensure the integrity of the ad request message during transit to a supply-side platform (SSP). The ad management application then sends an ad request message containing the augmented ad request to an SSP via a communication network, either directly or through a publisher ad server associated with the ad management application. The SSP analyzes the advertisements available from demand sources to identify and return digital ad assets associated with a digital advertisement to the ad management application via an ad response message. When the ad management application receives the ad response message, it provides the digital ad assets to the ad-requesting application through an ad response, which may also use an RPC protocol. The ad-requesting application may then display the digital advertisement to the user of the mobile device.

In some embodiments, the ad management application may further collect or receive telemetry and analytics data regarding display of and user interaction with the digital advertisement displayed by the ad-requesting application. The telemetry and analytics data may be received by the ad management application from the ad-requesting application through an analytics notification, which may be provided using an RPC protocol. Upon obtaining the telemetry and analytics data, the ad management application generates and sends an analytics message containing the telemetry and analytics data to the SSP, either directly or indirectly through a publisher ad server.

Several advantages are obtained by separating the digital advertisement acquisition and analytics functions from the ad-requesting application within a mobile computing environment. Security and privacy are improved by separating the permissions of the ad management application from the ad-requesting application, thereby allowing the ad management application to have more limited permissions than may be possible for some ad-requesting applications due to various functionalities required by such ad-requesting applications. Signal integrity of the ad requests is also improved by reducing the potential for manipulation by the ad-requesting applications, which is achieved through collection of local environmental data by the ad management application to generate augmented ad requests. Similarly, signal integrity of the ad requests is improved in transit by securing the messages, such as by the ad management application encrypting the payloads of ad request messages. Additionally, system storage and resource utilization is reduced because advertising SDKs are either eliminated entirely from ad-requesting applications or are greatly reduced in size, as all or most of their functionality is removed to the ad management application. Such separation further improves application analytics and error response by enabling attribution of crashes and other errors to either the ad management application or the ad-requesting application. Finally, locating ad management functionality in a separate ad management application enables changes to the functions of the ad management application without updating the ad-requesting applications, thereby saving both data transmission and processing resources previously involved in updating ad-requesting applications to update ad management functions.

Throughout this application, the terms “application” and “app” may be used interchangeably. Likewise, the terms “advertisement” and “ad” may be used interchangeably. The exemplary embodiments described herein are provided to better illustrate operation and aspects of the digital advertising techniques using an ad management application. In some embodiments, users may indicate willingness to allow access to some data regarding user characteristics or previous activity for the purpose of digital advertising (e.g., as part of a user profile) in order to obtain more relevant recommendations or digital advertisements, such as by operating certain controls or installing certain applications. Additional, alternative, or fewer components or aspects may be included in various further embodiments.

### Prior Art Digital Advertising Environment

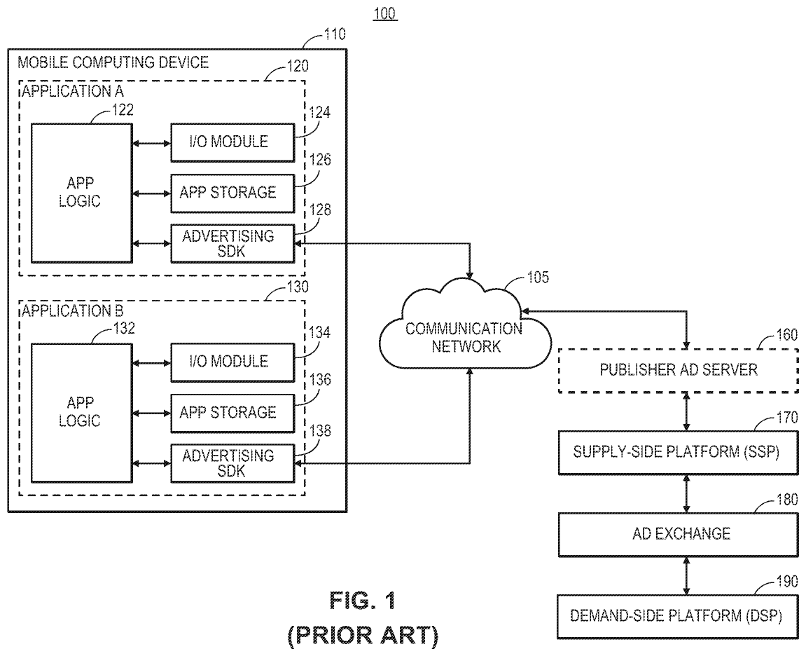

FIG. 1 illustrates an example prior art digital advertising system 100 for requesting, obtaining, and displaying digital advertisements via a mobile computing device 110. The mobile computing device 110 includes a plurality of native mobile applications configured to display digital advertisements to users, which comprise a plurality of modules or other components and are configured to run on the mobile computing device 110 as computer-readable instructions executed by one or more processors of the mobile computing device 110 and stored in a memory of the mobile computing device 110, such as those of the example computer system 600 described below. Some of the applications are ad-requesting applications that obtain and display digital advertisements to users from digital advertisers via a communication network 105. In the prior art digital advertising system 100, each ad-requesting application 120, 130 includes a separate advertising SDK 128, 138. Inclusion of the SDKs within the ad-requesting applications requires additional memory resources to store and run, as well as increasing the data transmitted via network communication when the ad-requesting applications are downloaded and installed. Moreover, inclusion of the SDKs within the ad-requesting applications reduces security and privacy because the advertising SDKs have the same level of permissions to access data and components of the mobile computing device 110 as the ad-requesting applications in which they reside.

Application A 120 includes app logic 122 comprising one or more modules configured to provide application functionality (e.g., displaying messages, maintaining calendar entries, or playing video or audio content). The app logic 122 interfaces with one or more input/output (I/O) modules 124 to receive input signals and provide output signals, such as via a touchscreen display of the mobile computing device 110. App storage 126 interfaces with the app logic 122 to store app-specific data, such as session or profile data used by the application. When the application A 122 determines a digital advertisement should be displayed to a user, the app logic 122 interacts with the advertising SDK 128 to obtain digital ad assets via communication with a publisher ad server 160 or supply-side platform (SSP) 170 via a communication network 105. Upon receiving digital ad assets via the advertising SDK 128, the app logic 122 causes part or all of the digital ad assets to be displayed to the user by appropriate output means via the I/O module 124. In some instances, the app logic 122 may further monitor user interaction with the digital advertisement via the I/O module 124 and provide analytics or telemetry data to the advertising SDK 128 to be further provided to the publisher ad server 160 or SSP 170 to track ad responses.

The advertising SDK 128 may be a third-party SDK incorporated into the application A 120 to provide digital advertising functionality. To obtain digital ad assets of a digital advertisement, the app logic 122 calls one or more routines within the advertising SDK 128 that generate ad request messages containing ad requests including local environment data regarding the mobile computing device 110, a user of the mobile computing device 110, or other aspects of the local device or user environment. For example, local environment data may include a type, age, and location of the mobile computing device 110, as well as user characteristics and application use or purchase profile of the device user. Because the advertising SDK 128 has the same access permissions for the mobile computing device 110 as the application A 120, it is possible for some applications to access user contacts, messages, call logs, movement or biometric data, photographs, and other data on the device. In some instances, the app logic 122 may collect or receive some or all of the local environment data (either directly or from routines of the advertising SDK 128), then provide such local environment data to a routine of the advertising SDK 128 for use in generating an ad request message. Such instances further provide the potential for substituting inaccurate data, either intentionally or inadvertently.

In any event, one or more routines of the advertising SDK 128 generate and send the ad request message via the communication network 105 to the SSP 170 for fulfillment. In some configurations, the ad request message is sent from the advertising SDK 128 to a publisher ad server 160 associated with the advertising SDK 128 (e.g., a first-party publisher of the application A 120 or a third-party publisher of the SDK 128), which then communicates the ad request message to the SSP 170. In some instances, the publisher ad server 160 may aggregate ad requests, augment ad requests with additional user profile data, or obfuscate user-specific data. The SSP 170 receives ad requests for a plurality of applications running on a plurality of mobile computing devices and fills such ad requests with digital advertisements through an ad exchange 180. The ad exchange 180 connects a plurality of SSPs 170 requesting digital advertisements with a plurality of demand-side platforms (DSPs) 190 providing digital advertisements from various digital advertisers. Prices and conditions of digital ad impressions are coordinated between the SSPs 170 and SDPs 190 via the ad exchange 180. The DSPs 190 also provide digital ad assets for the digital advertisements to the SSPs 170, which further provide the digital ad assets to the mobile computing devices selected for such digital advertisements. Thus, the advertising SDK 128 receives over the communication network 105 an ad response message containing digital ad assets from the SSP 170, either directly or via the publisher ad server 160. Upon receiving the ad response message, the advertising network 128 extracts the digital ad assets and provides the digital ad assets to the app logic 122 for display to the user.

In a similar manner, application B 130 includes app logic 132 comprising one or more modules configured to provide application functionality and to interface with an I/O module 134 for communicating with input and output components, an app storage 136, and an advertising SDK 138. The advertising SDK 138 operates similarly to the advertising SDK 128 to send ad request messages in response to commands from the app logic 132 and to receive and provide digital ad assets to the app logic 132 for display to the user. In some instances, the advertising SDK 128 and the advertising SDK 138 are copies of the same SDK provided by the same publisher, which are simply incorporated within different ad-requesting applications on the same mobile computing device 110.

Digital Advertising System with Ad Management Application

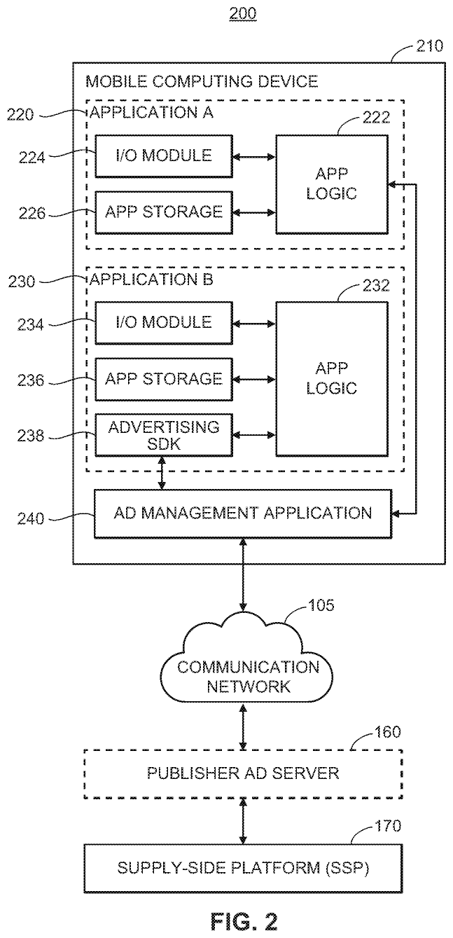

FIG. 2 illustrates an example digital advertising system 200 for requesting, obtaining, and displaying digital advertisements via a mobile computing device 210. Similar to the mobile computing device 110, the mobile computing device 210 includes a plurality of native mobile applications configured to display digital advertisements to users, which comprise a plurality of modules or other components and are configured to run on the mobile computing device 210 as computer-readable instructions executed by one or more processors of the mobile computing device 210 and stored in a memory of the mobile computing device 210, such as those of the example computer system 600 described below. In contrast to the mobile computing device 110, however, the mobile computing device 210 includes an ad management application 240 configured to handle ad requests from ad-requesting applications. Thus, ad requests from both application A 220 and application B 230 are sent to the ad management application 240, which augments such ad requests with local environment data and generates ad request messages to send to the publisher ad server 160 or the SSP 170.

By separating the collection of local environment data collection and the generation and communication of ad request messages from the individual ad-requesting applications, the ad management application 240 provides several advantages. Storage on the mobile computing device 210 is conserved by reducing or eliminating the inclusion of duplicate SDKs in multiple applications, thus reducing application size for each such application. By so reducing application size, network resources are similarly conserved while downloading such applications, both initially and when updating such applications. The potential for errors in the integration of advertising SKDs into applications is also reduced, thereby improving system stability. By moving the advertisement-related functionality from ad-requesting applications to a separate ad-management application 240, security and privacy is also enhanced within the mobile computing device 210 by enabling access permissions to be set specifically for digital advertisement management (i.e., separate sets of permissions are applied to the application A 220, the application B 230, and the ad management application 240). This reduces the number of attack targets for malicious software on the mobile computing device 210 and provides the user with greater control over personal information on the device.

The mobile computing device 210 has a plurality of ad-requesting applications installed on it, including application A 220 and application B 230. Analogously to the ad-requesting applications 120, 130 installed on the mobile computing device 110, application A 220 includes app logic 222, I/O module 224, and app storage 226, while application B includes app logic 232, I/O module 234, and app storage 236. In contrast to the ad-requesting applications 120, 130 of the mobile computing device 110, however, application A 220 does not include an advertising SDK. Although application B 230 includes a limited advertising SDK 238, such advertising SDK 238 is configured to communicate within the mobile computing device 210 between the app logic 232 and the ad management application 240. The ad management application 240 is separately installed within and runs as a separate application within the mobile computing device 210 to receive ad requests from ad-requesting applications and respond by providing digital ad assets to such ad-requesting applications.

The ad management application 240 is configured to received ad requests from one or more ad-requesting applications running on the mobile computing device 210, such as application A 220 and application B 230. In responses to such ad requests, the ad management application 240 is further configured to generate ad request messages and to send such ad request messages to an SSP 170, either directly or through a publisher ad server 160. Although the ad management application 240 may send ad request messages to the SSP 170 through a publisher ad server 160 in some embodiments, the ad management application 240 may not specifically designate the SSP 170. In such instances, the ad management application 240 is configured to communicate with the publisher ad server 160, while further communication between the publisher ad server 160 and the SSP 170 occurs without particular consideration of such communication by the ad management application 240. Thus, the ad management application 240 may be configured to send ad request messages to the SSP 170 and receive ad response messages from the SSP 170 without specific consideration of or knowledge of the specific SSP 170, via a publisher ad server 160.

In some embodiments, ad requests from the one or more ad-requesting applications comprise remote procedure calls (RPCs) from the ad-requesting applications to the ad management application 240. Such RPC ad requests may be received directly from an app logic 222 or from an advertising SDK 238 configured to provide such ad requests. By using structured intents of such RPCs to send ad requests to the ad management application 240, the ad request are significantly reduced relative to full ad request messages, enabling the ad requests to be generated by the app logic 222 or a limited advertising SDK 238 with significantly less code than is contained in existing adverting SDKs (such as advertising SDKs 128 and 138). For example, functionality relating to collection of local environment data, security of ad request messages, and network communication are not needed to send ad requests to the ad management application 240. In further embodiments, the ad requests include digital ad request information indicating a type of digital advertisement requested, such as text ads, image ads, video ads, audio ads, sizes or layout of ads, duration of ads, or related content (e.g., search terms or descriptions of categories of content associated with the ad-requesting application, such as sports apps, news apps, or weather apps). While such digital ad request information may improve the relevance of digital advertisements selected for the user, the ad management application 240 supplies additional local environment data regarding the mobile computing device 210 (e.g., device type, device age, or device location), regarding general user profile data (e.g., user characteristics or previous digital ad interaction), or regarding other general information associated with the device or the user. Thus, regardless of the data included in an ad request, in some embodiments, the ad management application 240 augments the ad request with local environment data when generating an ad request message.

As noted above, the ad management application 240 is configured to generate ad request messages based upon ad requests received from ad-requesting applications. The ad management application 240 is thus configured to augment received ad requests with local environment data and to generate ad request messages from such augmented ad requests. Obtaining local environment data may include collecting the local environment data from an operating system of the mobile computing device 210, accessing stored data, or generating such data based upon a combination of data sources. The ad management application 240 may further format, secure, wrap, or otherwise prepare the ad request for transmission in an ad request message. In some embodiments, the ad management application 240 is configured to cryptographically sign or encrypt the payloads (i.e., augmented ad requests) of ad request messages to prevent modification during transmission to the SSP 170. In such embodiments, the ad management application 240 may use a key associated with the ad management application 240 or a key associated with the mobile computing device 210. However generated, the ad request messages are sent by the ad management applications 240 from the mobile computing device 210 to either the publisher ad server 160 or the SSP 170 via the communication network 105.

In response to such ad request messages, the publisher ad server 160 and the SSP 170 may perform operations to negotiate, obtain, and return digital ad assets of a digital advertisement, as described above with respect to FIG. 1. Sending the ad request messages and receiving ad response messages may include direct or indirect control of hardware and software communication components of the mobile computing device 210 (e.g., the communication interface 605 of the computer system 600, discussed below). When the ad response message is returned, it is received by the ad management application 240, which then extracts provides the digital ad assets from the ad response message and provides the digital ad assets to the ad-requesting application (i.e., to app logic 222 of application A 220 or to advertising SDK 238 of application B 230) by sending an ad response to the ad-requesting application. In some embodiments, the ad management application 240 sends an ad response providing the digital ad assets of the digital advertisements to the ad-requesting applications using an RPC protocol (e.g., as structured intents) in response to RCP ad requests from such ad-requesting applications. In further embodiments, the ad management application 240 performs processing on the received digital ad assets after extraction from the ad response messages in order to prepare the advertisements for display by the ad-requesting applications (e.g., by adjusting an aspect ratio of the digital ad assets). In some embodiments, the ad management application 240 may provide the digital ad assets to the ad-requesting application by storing the digital ad assets in device storage of the mobile computing device 210 that is accessible to the ad-requesting application, then send an ad response indicating the location from which the ad-requesting application can retrieve such stored digital ad assets.

Upon receiving the ad response from the ad management application 240, the ad-requesting application proceeds to display the digital advertisement represented by the digital ad assets to the user according to the app logic 222, 232 of the respective application 220, 230. In some embodiments, the ad management application 240 is further configured to receive analytics notifications from ad-requesting applications after display of digital advertisements. Such an analytics notification may contain analytics data, telemetry data, or both relating to display of a digital advertisement to the user, which may include information relating to user interaction with one or more digital ad assets of the digital advertisement. In further embodiments, the ad management application 240 may be configured to obtain further analytics, telemetry, or other data relating to display of or user interaction with digital advertisements. In some such embodiments, the additional data may include screenshots, device logs, or other data to confirm display of or interaction with the digital ad assets. In further such embodiments, the additional data may include the state of other applications running on the mobile computing device 210 at the time of display or interaction. In response to receiving the analytics notification, the ad management application 240 is further configured to generate an analytics message based upon the analytics notification and send such analytics message to the publisher ad server 160 or the SSP 170. As with the ad request messages, the ad management application 240 may be configured to augment, format, secure, wrap, or otherwise prepare the data received in the analytics notification for transmission in the analytics message.

### Methods of Digital Advertising Using the Ad Management Application

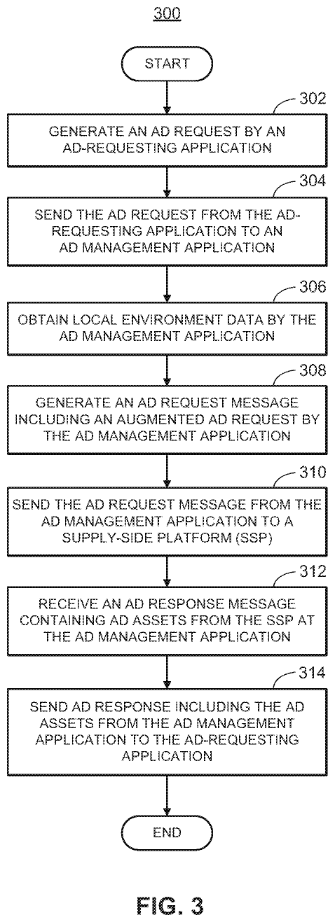

FIGS. 3-5 illustrate example methods of requesting, obtaining, displaying, and monitoring digital advertisements using an ad management application 240 of a mobile computing device 210 as described above. Each of the illustrated methods may be implemented in whole or part by a mobile computing device 210 having hardware components according to the computer system 600 (described below) communicatively connected to a publisher ad server 160 and/or SSP 170. The following methods are examples of various implementations selected to illustrate aspects of the disclosed invention, and additional, alternative, or fewer actions may be included in alternative embodiments.

FIG. 3 illustrates a flow diagram of an example digital ad request method 300 using an ad management application 240. The digital ad request method 300 begins with an ad-requesting application generating an ad request in order to obtain a digital advertisement (block 302) and sending the ad request to the ad management application 240 (block 304). Upon receiving the ad request, the ad management application 240 obtains local environment data to augment the ad request (block 306). The ad management application 240 then generates an ad request message including the augmented ad request (block 308) and sends the ad request message to the SSP 170 (block 310), either directly or through a publisher ad server 160. In response to the ad request message, the ad management application 240 receives an ad response message containing digital ad assets of a digital advertisement from the SSP 170 (block 312), which may be received through a publisher ad server 160. In response to receiving the ad request message, the ad management application 240 sends an ad response containing the digital ad assets of the digital advertisements to the ad-requesting application (block 314) for display to a user of the mobile computing device 210.

At block 302, the ad-requesting application (e.g., application A 220 or application B 230) generates an ad request to the ad management application 240. The ad-requesting application may generate the ad request in response to a triggering event, such as the ad-requesting application being loaded, a time elapses since a last digital advertisement was obtained, or a user interaction with the ad-requesting application. The ad request may be generated by the app logic 222 in an ad-requesting application without an advertising SDK (e.g., application A 220) or by an advertising SDK 238 in an ad-requesting application having a limited advertising SDK 238 (e.g., application B 230). In some embodiments, the ad request is generated using an RPC protocol, such as a structured intent between the ad-requesting application and the ad management application 240. In further embodiments, the ad requests include digital ad request information indicating a type of digital advertisement requested, such as text ads, image ads, video ads, audio ads, sizes or layout of ads, duration of ads, or related content.

At block 304, the ad-requesting application sends the ad request to the ad management application 240 within the mobile computing device 210. In some embodiments, the ad-requesting application sends the ad request using an RPC protocol (e.g., as a structured intent), thereby simplifying the communication between the ad-requesting application and the ad management application 240. In some embodiments, the ad-requesting application may check for availability of the ad management application 240 on the mobile computing device 210. In further embodiments, the ad-requesting application may identify multiple ad management applications operating on the mobile computing device 210 and select a preferred ad management application 240.

At block 306, the ad management application 240 obtains local environment data to augment the ad request from the ad-requesting application. The ad management application 240 collects, accesses, or generates the local environment data regarding the mobile computing device 210 (e.g., device type, device age, or device location), regarding general user profile data (e.g., user characteristics or previous digital ad interaction), or regarding other general information associated with the device or the user. In some embodiments, the local environment data comprises one or more of a type of the mobile computing device, an age of the mobile computing device, or a location of the mobile computing device. In further embodiments, the local environment data comprises one or more of a user identifier associated with the user, a user profile associated with the user, or one or more user characteristics associated with the user. Such local environment data may be accessed as or generated from parameters maintained by an operating system of the mobile computing device 210. Additionally or alternatively, such local environment data may be maintained by the ad management application 240 in a local user profile or in a remote user profile stored at a publisher ad server 160 identifiable by a user ID supplied by the ad management application 240.

By using the ad management application 240 to obtain the local environment data instead of the ad-requesting application, security and privacy are improved by allowing access permissions to be set specifically for digital advertising. Such digital advertising permissions may differ from the access permissions of the ad-requesting application. Thus, in some embodiments, the ad-requesting application has a first set of permissions for accessing resources of the mobile computing device 210, while the ad management application 240 has a second set of permissions for accessing resources of the mobile computing device 210 that is different from the first set of permissions. In such embodiments, the local environment data is collected by the ad management application 240 according to the limitations of the second set of permissions associated with the ad management application 240.

At block 308, the ad management application 240 generates an ad request message including the augmented ad request. In some embodiments, the ad request message is generated based upon the received ad request and the local environment data obtained by the ad management application 240 by generating an augmented ad request from the ad request and the local environment data. Such augmented ad request may be included in the ad request message as a payload, which may further be formatted, secured, wrapped, or otherwise prepared for transmission into the ad request message. For example, the ad management application 240 may wrap a cleartext or encrypted payload including the augmented ad request to generate the ad request message. In some embodiments, generating the ad request message comprises signing the ad request message with a cryptographic key on the mobile computing device 210, which may be a key maintained by the ad management application 240 or otherwise maintained by the mobile computing device 210, such as by an operating system of the mobile computing device 210. Securing the ad request message may be used to further protect integrity of the ad request in transit between the mobile computing device 210 and the SSP 170.

At block 310, the ad management application 240 sends the ad request message to the publisher ad server 160 or SSP 170 via the communication network 105. The ad request message is sent to the SSP 170 either directly from the ad management application 240 of the mobile computing device 210 or indirectly through the publisher ad server 160. If the latter, the publisher ad server 160 may either individually forward the ad request message (with or without further processing) or may aggregate a plurality of such ad request messages into an aggregate ad request message to the SSP 170. In some embodiments, the publisher ad server 160 may further augment the received ad request message with further user data (e.g., by adding user data from a user profile accessible by the publisher ad server 160 based upon a user ID added to the augmented ad request by the ad management application 240). In further embodiments, the publisher ad server 160 may remove or obfuscate user-identifiable data from the ad request message. In any event, the SSP 170 receives an ad request associated with the ad request message, negotiates a digital advertisement to fulfill the ad request via an ad exchange 180, and returns a digital advertisement including digital ad assets to the ad management application 240 (either directly or through the publisher ad server 160) via the communication network 105.

At block 312, an ad response message containing digital ad assets associated with a digital advertisement is received by the ad management application 240 from the publisher ad server 160 or SSP 170 via the communication network 105. The digital advertisement is thus provided to the mobile computing device 210 by the SSP 170 as one or more digital ad assets, such as text, image files, audio files, video files, or interactive content files. Upon receiving the ad response message, the ad management application 240 extracts the digital ad assets of the digital advertisement from the ad response message. In some embodiment, the digital ad assets may be secured by encryption in the ad response message, in which case the ad management application 240 decrypts the digital ad assets in order to provide them to the ad-requesting application.

At block 314, the ad management application 240 generates and sends an ad response to the ad-requesting application to provide the digital ad assets received in the ad response message. The one or more digital ad assets of the digital advertisement are thus provided to the ad-requesting application (e.g., to app logic 222 of application A 220 or to advertising SDK 238 of application B 230) by the ad management application 240 for display to the user of the mobile computing device 210. In some embodiments, the ad management application 240 may select or prepare the digital ad assets for display by the ad-requesting application prior to inclusion in the ad response, such that the digital ad assets are properly formatted for display by ad-requesting application. In some embodiments, the ad management application 240 may provide the digital ad assets to the ad-requesting application by storing the digital ad assets in device storage of the mobile computing device 210 that is accessible to the ad-requesting application, in which case the ad response may comprise an indication of the location of such stored digital ad assets. In some embodiments, the ad management application 240 sends an RPC ad response to the ad-requesting application using an RPC protocol (e.g., as structured intents). After receiving the ad response, the ad-requesting application may display the digital ad assets of the digital advertisement to the user, either immediately or upon occurrence of a triggering event (e.g., by caching the digital advertisement prior to display in order to reduce observed latency in displaying the digital advertisement).

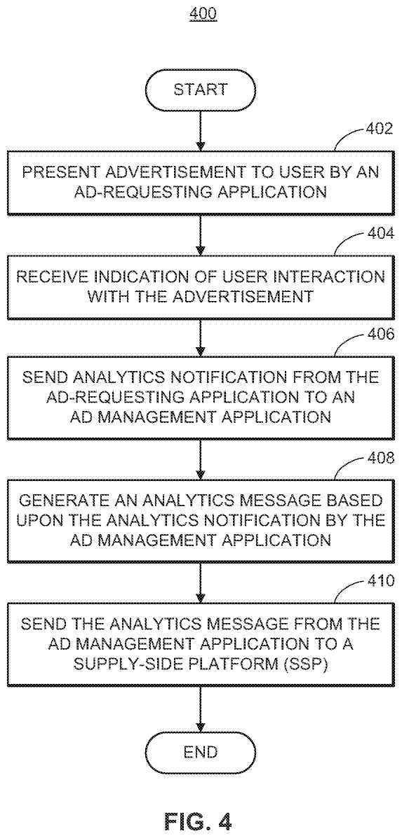

FIG. 4 illustrates a flow diagram of an example digital ad display method 400 using an ad management application 240. The digital ad display method 400 begins with the ad-requesting application displaying a digital advertisement received from the ad management application 240 to a user (block 402). Upon receiving an indication of user interaction with a displayed digital ad asset of the digital advertisement (block 404), the ad-requesting application sends an analytics notification to the ad management application 240 (block 406). The ad management application 240 then generates an analytics message in response to receiving the analytics notification (block 408) and sends the analytics message to the SSP 170 (block 410), either directly or through a publisher ad server 160.

At block 402, the ad-requesting application (e.g., application A 220 or application B 230) displays a digital advertisement comprising one or more digital ad assets to the user of the mobile computing device 210. The digital advertisement may be received from the ad management application 240, as discussed above. The ad-requesting application may display the digital ad assets via one or more of display screens, speakers, or connected output devices of the mobile computing device 210 via an I/O module (e.g., I/O module 224 or I/O module 234). Following display of the digital ad assets, the ad-requesting application may monitor user interaction with the digital advertisement.

At block 404, the ad-requesting application receives an indication of a user interaction of the user with at least one of the digital ad assets of the digital advertisement. Such user interaction may include direct user interaction (e.g., a user tapping or clicking on a portion of the digital advertisement) or indirect user interaction (e.g., user time spent on a page displaying the digital advertisement). Direct user interactions may be detected by a user input via an I/O module, while indirect user interactions may be determined by app logic of the ad-requesting application (e.g., app logic 222 or 232).

At block 406, the ad-requesting application generates and sends an analytics notification to the ad management application 240. Such analytics notification contains information regarding the user interaction, such as analytics data and/or telematics data regarding the user interaction with one or more digital ad assets of the digital advertisement. In some embodiments, the analytics notification is sent to the ad management application 240 using an RPC protocol (e.g., as a structured intent).

At block 408, the ad management application 240 generates an analytics message based upon the analytics notification received from the ad-requesting application. Upon receiving the analytics notification, in some embodiments, the ad management application 240 obtains additional data to supplement the analytics data and/or telematics data received from the ad-requesting application. Such additional data may include a screenshot at the time of receiving the analytics notification, which may be used to verify user interaction. In such embodiments, generating the analytics message may therefore include combining the received data with the additional data. In further embodiments, the ad management application 240 may further format, secure, wrap, or otherwise prepare the received data and any additional data for transmission in an analytics message.

At block 410, the ad management application 240 sends the analytics message to the publisher ad server 160 or SSP 170 via the communication network 105. The analytics message is sent to the SSP 170 either directly from the ad management application 240 of the mobile computing device 210 or indirectly through the publisher ad server 160. In either instance, the SSP 170 may record user interaction with such digital ad assets in order to determine relevant metrics regarding the digital advertisement, a digital advertising campaign, preferences or interests of the user, or other analysis purposes.

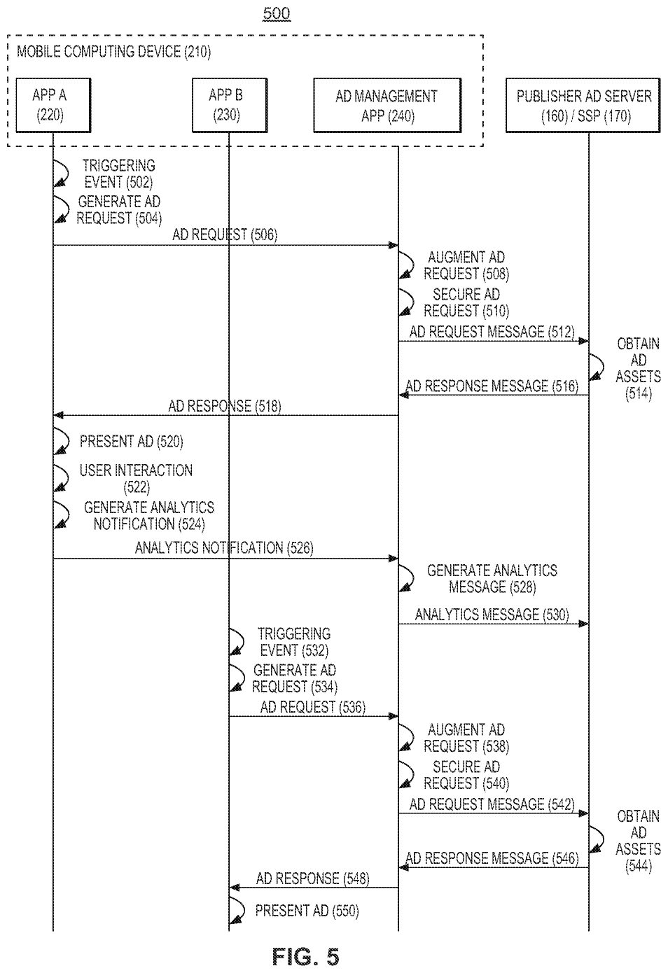

FIG. 5 illustrates a sequence diagram of an example digital ad provisioning process 500 using an ad management application 240. As illustrated, the application A 220, the application B 230, and the ad management application 240 communicate within the mobile computing device 210. The ad management application 240 further communicates externally with the publisher ad server 160 or the SSP 170 via the communication network 105 (not shown). The digital ad provisioning process 500 includes provisioning a digital advertisement to application A 220 and providing an analytics notification following a user interaction with such digital advertisement (lines 502-530), as well as provisioning an additional digital advertisement to application B 230 (lines 532-550). It is particularly noted that provisioning of the digital advertisements to both application A 220 and application B 230 occurs through the ad management application 240 within the same mobile computing device 210.

The digital ad provisioning process 500 beings with an occurrence of a triggering event (line 502) at application A 220. Such triggering event may comprise loading or opening the application A 220, passage of a time interval since a previous digital advertisement was received by the application A 220, or user interaction with the application A 220 facilitating display of a digital advertisement (e.g., a user opening a new page or view within the application). Upon the occurrence of such triggering event, the application A 220 generates an ad request (line 504) and sends the ad request to the ad management application 240 (line 506), such as by sending an RPC ad request within the mobile computing device 210. When the ad management application 240 receives the ad request, the ad management application 240 augments the ad request with local environment data (line 508) and secures the augmented ad request (line 510) to generate an ad request message. The ad management application 240 then sends the ad request message to the publisher ad serve 160 or SSP 170 via the communication network 105 (line 512). The publisher ad server 160 obtains digital ad assets from the SSP 170 (line 514), or the SSP 170 obtains digital ad assets from an ad exchange 180 (line 514). In either case, the publisher ad server 160 or SSP 170 sends an ad response message including the digital ad assets to the ad management application 240 via the communication network 105 (line 516). When the ad management application 240 receives the ad response message, the ad management application 240 extracts and provides the digital ad assets to the application A 220 by sending an ad response (line 518). When the application A 220 receives the ad response, the application A 220 displays the digital ad assets to a user (line 520). When a user interaction is detected (line 522), the application A 220 generates an analytics notification regarding the user interaction (line 524) and sends the analytics notification to the ad management application 240 (line 526). Upon receiving the analytics notification, the ad management application 240 generates an analytics message based upon the analytics notification (line 528) and sends the analytics message to the publisher ad server 160 or SSP 170 via the communication network 105 (line 530).

Next, the digital ad provisioning process 500 receives and fulfills an additional request for an additional digital advertisement for an additional ad-requesting application. The application B 230 detects the occurrence of a triggering event (line 532). In response to such triggering event, the application B 230 generates an ad request (line 534) and sends the ad request to the ad management application 240 (line 536), such as by sending an RPC ad request within the mobile computing device 210. When the ad management application 240 receives the ad request, the ad management application 240 augments the ad request with local environment data (line 538) and secures the augmented ad request (line 5540) to generate an ad request message. The ad management application 240 then sends the ad request message to the publisher ad serve 160 or SSP 170 via the communication network 105 (line 542). In response, the publisher ad serve 160 or SSP 170 obtains digital ad assets of a digital advertisement (block 544) and sends an ad response message containing such digital ad assets to the ad management application 240 via the communication network 105 (line 546). When the ad management application 240 receives the ad response message, the ad management application 240 extracts and provides the digital ad assets to the application B 230 by sending an ad response (line 548). Upon receiving the ad response, the application B 230 displays one or more digital assets of the digital advertisement to the user of the mobile computing device 210 (line 550).

### Example Mobile Computing Device

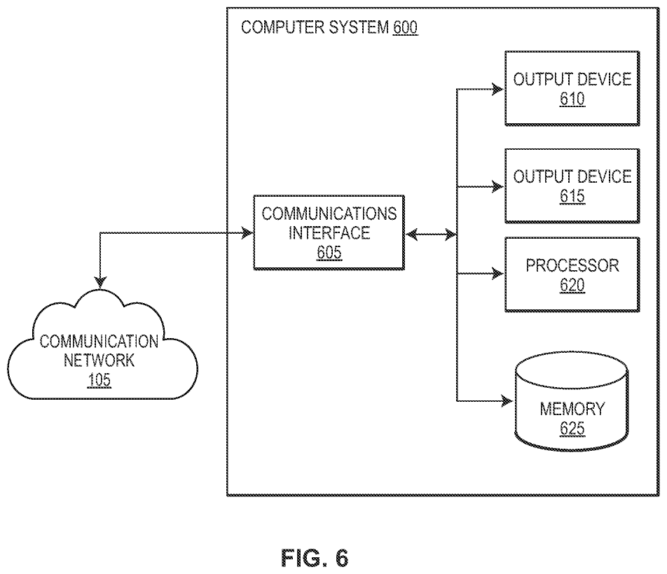

FIG. 6 illustrates a block diagram of an example computer system 600 for a mobile computing device, such as mobile computing device 110 or mobile computing device 210. The example computer system 600 illustrates the general architecture of such mobile computing devices in accordance with some implementations. The computer system 600 can be used to provide and receive information via the communication network 105. The computer system 600 comprises one or more processors 620 communicatively coupled to memory 625, one or more communications interfaces 605, and one or more output devices 610 (e.g., one or more display units or speakers) and one or more input devices 515 (e.g., one or more keyboards, touch screens, or microphones). The processors 620 can be used to execute computer-readable instructions to implement any of the applications or modules described herein, as well as additional functions of the computer system 600 (e.g., an operating system and further applications).

In the computer system 600, the memory 625 may comprise any computer-readable storage media, and may store computer instructions such as processor-executable instructions for implementing the various functionalities described herein for respective systems, as well as any data relating thereto, generated thereby, or received via the communications interface(s) or input device(s). With respect to the mobile computing device 210, the memory 625 may store executable instructions for implementing the ad-requesting applications (e.g., application A 220 and application B 230), the ad management application 240, an operating system, and any further applications, modules, or routines installed or running on the mobile computing device 210. The processor(s) 620 may be used to execute instructions stored in the memory 625 and, in so doing, also may read from or write to the memory various information processed and or generated pursuant to execution of the instructions.

The processor 620 of the computer system 600 also may be communicatively coupled to or control the communications interface(s) 605 to transmit or receive various information pursuant to execution of instructions. For example, the communications interface(s) 605 may be coupled to a wired or wireless network, bus, or other communication means and may therefore allow the computer system 600 to transmit information to or receive information from other devices (e.g., other computer systems, such as the publisher ad server 160 or the SSP 170).

The output devices 610 of the computer system 600 may be provided, for example, to allow various information to be viewed or otherwise perceived in connection with execution of the instructions. The input device(s) 615 may be provided, for example, to allow a user to make manual adjustments, make selections, enter data, or interact in any of a variety of manners with the processor during execution of the instructions. Additional information relating to a general computer system architecture that may be employed for various systems discussed herein is provided further herein.

Implementations of the subject matter and the operations described in this specification can be implemented in digital electronic circuitry, or in computer software embodied on a tangible medium, firmware, or hardware, including the structures illustrated in FIG. 6 with respect to the computer system 600 and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. The program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can include a source or destination of computer program instructions encoded in an artificially generated propagated signal. The computer storage medium can also be, or be included in, one or more separate physical components or media (e.g., multiple CDs, disks, or other storage devices).

### ADDITIONAL CONSIDERATIONS

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain embodiments are described herein as including logic or a number of components, modules, or mechanisms. Modules may constitute either software modules (e.g., code stored on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

A hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module in dedicated and permanently configured circuitry or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware and software modules can provide information to, and receive information from, other hardware and/or software modules. Accordingly, the described hardware modules may be regarded as being communicatively coupled. Where multiple of such hardware or software modules exist contemporaneously, communications may be achieved through signal transmissions (e.g., over appropriate circuits and buses, which may include one or more central processors) that connect the hardware or software modules. In embodiments in which multiple hardware modules or software are configured or instantiated at different times, communications between such hardware or software modules may be achieved, for example, through the storage and retrieval of information in memory structures to which the multiple hardware or software modules have access. For example, one hardware or software module may perform an operation and store the output of that operation in a memory device to which it is communicatively coupled. A further hardware or software module may then, at a later time, access the memory device to retrieve and process the stored output. Hardware and software modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as an SaaS. For example, as indicated above, at least some of the operations may be performed by a group of computers (as examples of machines including processors), these operations being accessible via a network (e.g., the Internet) and via one or more appropriate interfaces (e.g., APIs).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” or a “routine” is a self-consistent sequence of operations or similar processing leading to a desired result. In this context, algorithms, routines and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment,” “an embodiment,” or “some embodiments” means that a particular element, feature, structure, or characteristic described in connection with the embodiment is included in at least one embodiment. The appearances of such phrases in various places in the specification are not necessarily all referring to the same embodiment.

Some embodiments may be described using the expression “coupled,” “connected,” or “communicatively connected,” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present). The term “and/or” at certain points herein is used for particular emphasis and not in contradistinction to the term “or” used elsewhere herein.

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Upon reading this disclosure, those of skill in the art will appreciate still additional alternative structural and functional designs for preserving privacy during a navigation session through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A computer-implemented method in a mobile computing device, comprising:
receiving, by one or more processors of the mobile computing device, an ad request from an ad-requesting application operating on the mobile computing device to an ad management application operating on the mobile computing device;
generating, by the one or more processors, an ad request message via the ad management application based upon the ad request;
sending, by the one or more processors, the ad request message from the ad management application to a supply-side platform server of a digital advertising network via a communication network;
receiving, at the one or more processors, an ad response message from the supply-side platform server to the ad management application in response to the ad request message, wherein the ad response message includes one or more digital ad assets associated with a digital advertisement; and
sending, by the one or more processors, an ad response from the ad management application to the ad-requesting application, wherein the ad response includes the one or more digital ad assets for display to a user of the mobile computing device by the ad-requesting application.

2. The computer-implemented method of claim 1, wherein the ad request comprises a remote procedure call from the ad-requesting application to the ad management application.

3. The computer-implemented method of claim 1, wherein:
the ad request message contains an augmented ad request; and
generating the ad request message comprises (i) collecting local environment data associated with the mobile computing device and (ii) augmenting information of the ad request with the local environment data to generate the augmented ad request.

4. The computer-implemented method of claim 3, wherein:
the ad-requesting application has a first set of permissions for accessing resources of the mobile computing device;
the ad management application has a second set of permissions for accessing resources of the mobile computing device that is different from the first set of permissions; and
the local environment data is collected by the ad management application according to the limitations of the second set of permissions.

5. The computer-implemented method of claim 3, wherein the local environment data comprises one or more of a type of the mobile computing device, an age of the mobile computing device, or a location of the mobile computing device.

6. The computer-implemented method of claim 3, wherein the local environment data comprises one or more of a user identifier associated with the user, a user profile associated with the user, or one or more user characteristics associated with the user.

7. The computer-implemented method of claim 1, wherein generating the ad request message comprises signing the ad request message with a cryptographic key on the mobile computing device.

8. The computer-implemented method of claim 1, further comprising:
receiving, by the one or more processors, an analytics notification from the ad-requesting application to the ad management application, wherein the analytics notification contains one or both of telemetry data or analytics data regarding interaction of the user with the one or more digital ad assets displayed by the ad-requesting application;
generating, by the one or more processors, an analytics message via the ad management application based upon the analytics notification; and
sending, by the one or more processors, the analytics message from the ad management application to the supply-side platform server via the communication network.

9. The computer-implemented method of claim 1, further comprising:
receiving, by the one or more processors, an additional ad request from an additional ad-requesting application operating on the mobile computing device to the ad management application;
generating, by the one or more processors, an additional ad request message via the ad management application based upon the additional ad request;
sending, by the one or more processors, the additional ad request message from the ad management application to the supply-side platform server via the communication network;
receiving, at the one or more processors, an additional ad response message from the supply-side platform server to the ad management application in response to the additional ad request message, wherein the additional ad response message includes one or more additional digital ad assets; and
sending, by the one or more processors, an additional ad response from the ad management application to the additional ad-requesting application, wherein the additional ad response includes the one or more additional digital ad assets for display to the user of the mobile computing device by the additional ad-requesting application.

10. The computer-implemented method of claim 1, wherein the ad-requesting application is a native mobile application without an advertising software development kit.

11. A mobile computing device, comprising:
one or more processors; and
a computer-readable memory coupled to the one or more processors and storing instructions thereon that, when executed by the one or more processors, cause the mobile computing device to:
receive an ad request from an ad-requesting application operating on the mobile computing device to an ad management application operating on the mobile computing device;
generate an ad request message via the ad management application based upon the ad request;
send the ad request message from the ad management application to a supply-side platform server of a digital advertising network via a communication network;
receive an ad response message from the supply-side platform server to the ad management application in response to the ad request message, wherein the ad response message includes one or more digital ad assets associated with a digital advertisement; and
send an ad response from the ad management application to the ad-requesting application, wherein the ad response includes the one or more digital ad assets for display to a user of the mobile computing device by the ad-requesting application.

12. The mobile computing device of claim 11, wherein the ad request comprises a remote procedure call from the ad-requesting application to the ad management application.

13. The mobile computing device of claim 11, wherein:
the ad request message contains an augmented ad request; and
the instructions that cause the mobile computing device to generate the ad request message cause the mobile computing device to (i) collect local environment data associated with the mobile computing device and (ii) augment information of the ad request with the local environment data to generate the augmented ad request.

14. The mobile computing device of claim 13, wherein:
the ad-requesting application has a first set of permissions for accessing resources of the mobile computing device;
the ad management application has a second set of permissions for accessing resources of the mobile computing device that is different from the first set of permissions; and
the local environment data is collected by the ad management application according to the limitations of the second set of permissions.

15. The mobile computing device of claim 11, wherein the ad-requesting application is a native mobile application without an advertising software development kit.

16. A computer-readable memory coupled to one or more processors and storing instructions thereon that, when executed by the one or more processors of a mobile computing device, cause the one or more processors to:
receive an ad request from an ad-requesting application operating on the mobile computing device to an ad management application operating on the mobile computing device;
generate an ad request message via the ad management application based upon the ad request;
send the ad request message from the ad management application to a supply-side platform server of a digital advertising network via a communication network;
receive an ad response message from the supply-side platform server to the ad management application in response to the ad request message, wherein the ad response message includes one or more digital ad assets associated with a digital advertisement; and
send an ad response from the ad management application to the ad-requesting application, wherein the ad response includes the one or more digital ad assets for display to a user of the mobile computing device by the ad-requesting application.

17. The computer-readable memory of claim 16, wherein the ad request comprises a remote procedure call from the ad-requesting application to the ad management application.

18. The computer-readable memory of claim 16, wherein:
the ad request message contains an augmented ad request; and
the instructions that cause the one or more processors to generate the ad request message cause the one or more processors to (i) collect local environment data associated with the mobile computing device and (ii) augment information of the ad request with the local environment data to generate the augmented ad request.

19. The computer-readable memory of claim 18, wherein:
the ad-requesting application has a first set of permissions for accessing resources of the mobile computing device;
the ad management application has a second set of permissions for accessing resources of the mobile computing device that is different from the first set of permissions; and
the local environment data is collected by the ad management application according to the limitations of the second set of permissions.

20. The computer-readable memory of claim 16, wherein the ad-requesting application is a native mobile application without an advertising software development kit.
